(19) United States
(12) Patent Application Publication
(10) Pub. No.: US 2019/0160317 A1
(43) Pub. Date: May 30, 2019

(54) AIRCRAFT AND METHOD FOR MONITORING A CONCENTRATION OF FIRE-EXTINGUISHING AGENT IN A CARGO HOLD

(71) Applicant: Airbus Operations GmbH, Hamburg (DE)

(72) Inventors: Konstantin Kallergis, Hamburg (DE); Jose Maria Sanchez Garcia-Del Toro, Hamburg (DE)

(73) Assignee: Airbus Operations GmbH, Hamburg (DE)

(21) Appl. No.: 16/197,632

(22) Filed: Nov. 21, 2018

(30) Foreign Application Priority Data
Nov. 30, 2017 (DE) 10 2017 128 486.9

(51) Int. Cl. A62C 37/50; A62C 3/08; B64D 45/00; B64D 25/00

(52) U.S. Cl. CPC A62C 37/50; A62C 3/08; B64D 2045/009; B64D 25/00; B64D 45/00

(57) ABSTRACT

An aircraft has: a cargo hold, a first fire-extinguishing agent container with a fluid-like fire-extinguishing agent, a first line section extending from the first container to the cargo hold, such that the fire-extinguishing agent can flow from the first container into the cargo hold, a controllable valve coupled to the first line section for controlling a flow of fire-extinguishing agent through the first line section, a concentration sensor arranged in the cargo hold for sensing a concentration of the fire-extinguishing agent in the cargo hold, and a monitoring unit. The concentration sensor is coupled to the monitoring unit for transmitting to the monitoring unit a concentration sensor signal representing the sensed concentration of the fire-extinguishing agent in the cargo hold. The monitoring unit is coupled, to the valve for controlling the valve. The monitoring unit is configured to control the valve on the basis of the sensed concentration.

### FIELD OF THE INVENTION

The invention relates to an aircraft which is designed to monitor the concentration of a fire-extinguishing agent in the cargo hold of the aircraft. Furthermore, the invention relates to a method for monitoring the concentration of fire-extinguishing agent in the cargo hold.

### BACKGROUND OF THE INVENTION

Aircraft are often divided into different areas. One of these areas of the aircraft can form, for example, the passenger cabin. A further area of the aircraft can be the cargo hold of the aircraft. The cargo hold is often arranged underneath the passenger cabin. In order to suppress or extinguish a fire in the cargo hold it is known that a fire-extinguishing system can be installed in the aircraft, which system has at least one fire-extinguishing agent container which is coupled to the cargo hold via a fluid line. If a fire is detected in the cargo hold, a closure which cannot be closed again is opened on the fire-extinguishing container by means of a pyrotechnic charge, with the result that the fire-extinguishing agent flows from the fire-extinguishing agent container into the cargo hold through the fluid line, which brings about the desired suppression or extinguishing of the fire.

The fire-extinguishing system in the aircraft is usually structurally configured here in such a way that the quantity of the fire-extinguishing agent which flows into the cargo hold can also be suitable for extinguishing a fire which represents an at least theoretically unfavourable case. Therefore, as soon as a fire is detected, the same quantity of fire-extinguishing agent is introduced into the cargo hold irrespective of the extent of a detected fire in the cargo hold.

However, the fire-extinguishing agent which is used at present can have an adverse effect on the environment. Therefore, if, for example, a small fire is extinguished with a large quantity of fire-extinguishing agent, it may be the case that at least some of the quantity of fire-extinguishing agent which is used would not have been necessary.

### BRIEF SUMMARY OF THE INVENTION

An aspect of the invention may make available an aircraft and a method for an aircraft which makes it possible to ensure the quantity of fire-extinguishing agent which is to be used to extinguish or suppress a fire in a cargo hold of the aircraft.

According to an embodiment, an aircraft is provided which has a cargo hold, a first fire-extinguishing agent container with a fluid-like fire-extinguishing agent and a first line section which extends from the first fire-extinguishing agent container to the cargo hold, with the result that the fire-extinguishing agent can flow from the first fire-extinguishing agent container into the cargo hold. Furthermore, the aircraft has a controllable valve which is coupled to the first line section in such a way that a flow of the fire-extinguishing agent through the first line section can be controlled by means of the valve. The aircraft also has a concentration sensor which is preferably arranged in the cargo hold and is designed to sense a concentration of the fire-extinguishing agent in the cargo hold. Moreover, the aircraft has a monitoring unit, wherein the concentration sensor is coupled, in particular electrically, to the monitoring unit in such a way as to transmit to the monitoring unit a concentration signal which represents the sensed concentration of the fire-extinguishing agent in the cargo hold. Furthermore, in order to control the valve, the monitoring unit is coupled to the valve in such a way that the flow of fire-extinguishing agent can be controlled by controlling the valve by means of the monitoring unit. Finally, the monitoring unit is configured to control the valve on the basis of the sensed concentration in such a way that the concentration of the fire-extinguishing agent in the cargo hold corresponds to or assumes a predetermined value or is within a predetermined value range.

By means of the concentration sensor, the monitoring unit and the controllable valve, a situation is now possible in which only the quantity of fire-extinguishing agent which is sufficient and necessary to extinguish and/or suppress a fire in the cargo hold has to be introduced into the cargo hold. In other words, the aircraft is now designed to regulate the desired concentration of fire-extinguishing agent in the cargo hold effectively and in an environmentally aware fashion. If for example a plurality of objects are accommodated as cargo in the cargo hold, the residual free area, that is to say the part of the cargo hold which is not used by the freight, is reduced. If a fire then occurs in the cargo hold, a relatively small quantity of fire-extinguishing agent is often necessary to extinguish and/or suppress the fire in the cargo hold. This is because the fire-extinguishing agent which is introduced into the cargo hold brings about a correspondingly high concentration of fire-extinguishing agent significantly more quickly in the residual free area of the cargo hold. The fire can therefore be extinguished particularly quickly and efficiently even with a relatively small quantity of fire-extinguishing agent. The concentration sensor can continuously sense the sensed concentration in the cargo hold here, in particular in the residual empty area of the cargo hold. If the desired concentration of fire-extinguishing agent, which concentration corresponds to the predetermined value or is at least within the predetermined value ranges, is reached, the valve can be controlled by means of the monitoring unit in such a way that no further fire-extinguishing agent is introduced into the cargo hold. If the concentration of fire-extinguishing agent were to drop, this can be sensed by means of the concentration sensor, which sends a corresponding signal to the monitoring unit. In this case, the valve can be controlled by means of the monitoring unit in such a way that fire-extinguishing agent flows into the cargo hold again until the actual concentration corresponds to the predetermined value or is at least within the predetermined value ranges. In this way, the concentration of fire-extinguishing agent in the cargo hold is regulated effectively and at the same time in an environmentally conscious fashion.

However, other scenarios of a fire in the cargo hold can also be extinguished by means of the concentration sensor, the monitoring unit and the controllable valve. If, for example, 90% of the cargo hold is occupied by cargo, with the result that the residual free area of the cargo hold is particularly small, and, moreover, when a fire occurs there is a breakthrough and/or another leakage of the cargo hold, particularly rapid exchange of the air/fire-extinguishing agent mixture can occur within the residual free area in the cargo hold. Even though the residual free area makes up a small part of the cargo hold, it nevertheless requires, in terms of quantity, a large flow of fire-extinguishing agent which has to be fed to the cargo hold in order to extinguish and/or suppress the fire. Since the concentration of fire-extinguishing agent in the cargo hold can be sensed, in particular continuously, by means of the concentration sensor, the monitoring unit can control the controllable valve in such a way that even in such a scenario the desired concentration of fire-extinguishing agent is maintained or remains in the cargo hold. In this scenario also, the fire can therefore be effectively extinguished and/or suppressed.

A fluid-like fire-extinguishing agent is preferably understood to be a fluid, that is to say, for example, a gaseous fire-extinguishing agent and/or a liquid fire-extinguishing agent, which is suitable for extinguishing and/or designed to extinguish a fire.

The first fire-extinguishing agent container is designed to supply the fluid-like fire-extinguishing agent. The first fire-extinguishing agent container is preferably embodied in a gas-tight and/or fluid-tight fashion. The first fire-extinguishing agent container is particularly preferably embodied in a hermetically sealed fashion.

The first line section has at least one fluid line. The first line section can therefore also be referred to as a first fluid line section. The first line section particularly preferably has a plurality of fluid lines which are coupled to one another in a fluid-tight fashion such that the fire-extinguishing agent can flow through the corresponding line section or the associated fluid lines. The controllable valve is particularly preferably coupled between two of the fluid lines. Each of the two fluid lines is particularly preferably coupled in a fluid-tight fashion to the controllable valve here. The first line section can therefore extend from the first fire-extinguishing agent container to the controllable valve and then on from the controllable valve to the cargo hold. In other words, the controllable valve can be coupled between two sections of the first line section.

The controllable valve is designed to control a flow of fire-extinguishing agent through the valve and therefore through the first line section. The controllable valve is embodied, for example, as a controllable throttle valve. The controllable valve is preferably electrically coupled to the monitoring unit via an electrical valve control line. Electrical coupling can preferably be understood to mean an electrical connection. It follows from this that the valve can be electrically connected to the monitoring unit via an electrical valve control line. The monitoring unit can be embodied as an electrical monitoring unit. The monitoring unit can transmit control signals to the controllable valve via the valve control signal line, in order to control the controllable valve. The controllable valve can therefore be embodied as an electromechanical controllable valve. Furthermore, there is preferably provision that the outlet cross section of the controllable valve can be controlled by the monitoring unit, in particular by corresponding actuation via the valve control signal line.

The concentration sensor serves to sense a concentration of the fire-extinguishing agent in the cargo hold of the aircraft. In other words, the concentration sensor is designed to sense the corresponding concentration. The concentration sensor is preferably completely or at least partially arranged in the cargo hold. However, there can also be provision that the concentration sensor is connected to the cargo hold via a hose, a pipe or another fluid line. A measured volume at the concentration sensor can then be fed. If the fire-extinguishing agent flows into the cargo hold, the fire-extinguishing agent is usually distributed in the cargo hold. This in turn brings about a corresponding concentration of fire-extinguishing agent in the cargo hold. In practice it has been found that effective extinguishing or suppression of a fire can be ensured starting from a specific concentration of the fire-extinguishing agent in the cargo hold. A corresponding, predetermined value of the concentration of the fire-extinguishing agent in the cargo hold can therefore be determined in advance. The predetermined value of the concentration of the fire-extinguishing agent in the cargo hold is preferably saved and/or stored in the monitoring unit. Alternatively or additionally, there can be provision that a predetermined value range for the concentration of the fire-extinguishing agent in the cargo hold is saved and/or stored in the monitoring unit. In this context, the predetermined value of the concentration of the fire-extinguishing agent can form the lower limiting value of the value range. The upper limiting value of the value range is preferably higher than the above-mentioned predetermined value. The upper limiting value can therefore preferably be at least 10%, 20%, 30%, 40%, 50% or higher than the predetermined value of the concentration of the fire-extinguishing agent in the cargo hold. Other predetermined value ranges for the concentration of the fire-extinguishing agent in the cargo hold are also possible. Such predetermined value ranges can also be saved and/or stored in the monitoring unit.

If a fire has not been detected in the cargo hold, the monitoring unit can be designed to close the controllable valve. This prevents fire-extinguishing agent from flowing from the first fire-extinguishing agent container into the cargo hold without reason. If, on the other hand, a fire has been detected in the cargo hold, a corresponding initiation signal can be transmitted to the monitoring unit. In order to control the valve, the monitoring unit is coupled to the valve in such a way that the flow of fire-extinguishing agent can be controlled by controlling the valve by means of the monitoring unit. The monitoring unit can therefore open the controllable valve in a monitored fashion. In particular, the monitoring unit can be designed to monitor the size of the outlet cross section of the controllable valve in a controlled fashion. Furthermore, the monitoring unit is designed and/or configured to control the valve on the basis of the concentration, sensed by means of the concentration sensor, of fire-extinguishing agent in the cargo hold in such a way that the actual concentration of the fire-extinguishing agent in the cargo hold corresponds to the predetermined value for the (desired) concentration of the fire-extinguishing agent and/or that the actual concentration of the fire-extinguishing agent in the cargo hold is within a (desired) predetermined value range for the fire-extinguishing agent in the cargo hold. The predetermined value or the predetermined value range is preferably predetermined here in such a way that effective extinguishing or suppression of a fire in the cargo hold is ensured.

An advantageous refinement of the aircraft is distinguished by the fact that the aircraft has a flow sensor. The flow sensor is coupled to the first line section in such a way that a flow of fire-extinguishing agent through the first line section can be sensed by the flow sensor. Furthermore, the flow sensor is coupled, in particular electrically, to the monitoring unit in such a way as to transmit a flow sensor signal to the monitoring unit, which signal represents the sensed flow of fire-extinguishing agent. In this context, the monitoring unit is preferably configured to control the controllable valve also on the basis of the sensed flow of fire-extinguishing agent. By means of the further sensor information of the flow sensor, the desired concentration of fire-extinguishing agent in the cargo hold can be compensated even more precisely and/or quickly in the case of possible fluctuations in the actual concentration. The flow sensor is preferably designed to sense a volume flow and/or a mass flow of fire-extinguishing agent through the line section. The flow of fire-extinguishing agent can therefore be, for example, a volume flow of fire-extinguishing agent or a mass flow of fire-extinguishing agent. The flow sensor can be attached to a sensor connection of a fluid line of the line section. Alternatively or additionally, the flow sensor can be embodied in such a way that the flow sensor is coupled in a fluid-tight fashion between two fluid lines of the line section, with the result that the flow of extinguishing agent can also flow through the flow sensor as such. Furthermore, there is preferably provision that the flow sensor is electrically coupled to the monitoring unit via an associated sensor line, wherein the corresponding sensor line is designed to transmit the flow sensor signal to the monitoring unit. The flow sensor is particularly preferably an electrical flow sensor.

A further advantageous refinement of the aircraft is distinguished by the fact that the aircraft has a first closure which is coupled to the first line section in such a way that opening of the first closure ensures and/or brings about a flow of fire-extinguishing agent from the first fire-extinguishing agent container to the controllable valve. The first closure provides the advantage that the fire-extinguishing agent or the flow of fire-extinguishing agent does not act on the controllable valve at all times. Instead, there is preferably provision that the first closure is only opened when a fire is actually detected in the cargo hold. Otherwise there is preferably provision that the first closure remains closed. Therefore, the functional reliability of the controllable valve can be ensured with particular certainty. The first closure is preferably arranged directly at the transition between the first fire-extinguishing agent container and the first line section. It can therefore be ensured that the fire-extinguishing agent remains at least essentially exclusively in the first fire-extinguishing agent container as long as a fire has not been detected in the cargo hold. The first closure is preferably securely attached to the first fire-extinguishing agent container. In this way, the first closure can be assigned to the first fire-extinguishing agent container. Furthermore, there is preferably provision that the first closure is embodied as a closure which can be destroyed by firing a pyrotechnic charge. The corresponding pyrotechnic charge can be assigned to the first closure and/or can form part of the first closure. The pyrotechnic charge can preferably be fired by an electrical signal.

A further advantageous refinement of the aircraft is distinguished by the fact that the first closure is embodied as a first single-use closure. The single-use closure is therefore preferably embodied in such a way that it cannot be closed again after opening. Instead, the opening of the first closure can cause a closure means of the first closure to be destroyed, with the result that a free line passage is made available through the first closure, which then ensures the flow of fire-extinguishing agent from the first fire-extinguishing agent container into the first line section. In other words, the first closure can be configured as a closure which cannot be closed again. Moreover, a single-use closure makes a particularly low level of complexity and/or a particularly low probability of failure possible. Such a single-use closure is therefore particularly functionally reliable.

A further advantageous refinement of the aircraft is distinguished by the fact that the first closure is coupled, in particular electrically, to the monitoring unit in such a way that the first closure can be opened, in particular irreversibly, by means of the monitoring unit. The pyrotechnic charge is preferably embodied in such a way that it can be fired, in particular electrically, by means of the monitoring unit. This then brings about the opening of the first closure.

A further advantageous refinement of the aircraft is distinguished by the fact that the aircraft also has a second fire-extinguishing agent container with a or the same fluid-like fire-extinguishing agent. Furthermore, the aircraft preferably has a second line section which extends from the second fire-extinguishing agent container to the cargo hold, with the result that fire-extinguishing agent can flow from the second fire-extinguishing agent container into the cargo hold. Moreover, there is preferably provision that the aircraft has a second closure which is coupled to the first line section in such a way that opening of the second closure brings about an, in particular unmonitored and/or, for example unregulated, flow of fire-extinguishing agent from the second fire-extinguishing agent container to the cargo hold through the second line section.

In practice it has proven advantageous if at least two separate fire-extinguishing agent containers, specifically at least the first fire-extinguishing agent container and at least the second fire-extinguishing agent container, are provided for an aircraft, in order to be able to extinguish a fire in the cargo hold using fire-extinguishing agent. Furthermore, it has proven advantageous if the same fire-extinguishing agent is supplied by both fire-extinguishing agent containers. This facilitates, in particular, the sensing of the concentration of the fire-extinguishing agent in the cargo hold by means of the concentration sensor. As a result, particularly rapid and effective adaptation of the flow of fire-extinguishing agent into the cargo hold can also be ensured by means of the monitoring unit and the controllable valve. For the second line section, reference is preferably made in an analogous fashion to the advantageous explanations, preferred features, effects and/or advantages such as have been explained in conjunction with the first line section. The second line section can also be referred to as a second fluid line section. The second line section particularly preferably has a plurality of fluid lines which are coupled to one another in a fluid-tight fashion such that the fire-extinguishing agent can flow through the corresponding line section or the associated fluid lines.

If a fire is sensed in the cargo hold, there can be provision that the second closure is opened, with the result that fire-extinguishing agent flows from the second fire-extinguishing agent container into the cargo hold through the second line section. This can take place in parallel with flowing of fire-extinguishing agent from the first fire-extinguishing agent container into the cargo hold via the first line section. In other words, fire-extinguishing agent can be directed from both fire-extinguishing agent containers into the cargo hold. The desired concentration of fire-extinguishing agent in the cargo hold can therefore be achieved particularly quickly. The second closure is preferably embodied as a closure which can be destroyed by firing a pyrotechnic charge. This pyrotechnic charge can be assigned to the second closure, or the second closure can have this pyrotechnic charge. This pyrotechnic charge can be capable of being fired, in particular, by an electrical signal.

If the second closure is opened, for example by firing the associated pyrotechnic charge, the fire-extinguishing agent flows from the second fire-extinguishing agent container into the cargo hold through the second line section. There is particularly preferably provision that the second line section does not have a valve or a further valve and/or a controllable element or a further controllable element which could limit the flow of fire-extinguishing agent from the second fire-extinguishing agent container to the cargo hold in a controlled fashion. As a result, when the second closure opens the fire-extinguishing agent flows from the second fire-extinguishing agent container in an uncontrolled, unregulated and/or unmonitored fashion from the second fire-extinguishing agent container to the cargo hold through the second line section. This flow of fire-extinguishing agent therefore does not stop until the fire-extinguishing agent has at least essentially completely flowed into the cargo hold. This ensures a corresponding increase in the concentration of fire-extinguishing agent in the cargo hold. The concentration sensor can sense the corresponding increase in the fire-extinguishing agent in the cargo hold. Furthermore, the concentration sensor can transmit a corresponding concentration sensor signal to the monitoring unit. On the basis of the predetermined value or the predetermined value range for the desired concentration of the fire-extinguishing agent in the cargo hold, the monitoring unit can be configured to control the controllable valve in such a way that the predetermined value or the predetermined value range for the desired concentration of the fire-extinguishing agent in the cargo hold is maintained and/or achieved. In other words, despite the “at least essentially passive” flowing of the fire-extinguishing agent from the second fire-extinguishing agent container into the cargo hold, the concentration of the fire-extinguishing agent in the cargo hold can be regulated, specifically by the actuation of the controllable valve by means of the monitoring unit and on the basis of the concentration sensor signal of the concentration sensor, wherein the concentration sensor signal represents the previously sensed concentration of the fire-extinguishing agent in the cargo hold.

The second closure is preferably arranged immediately at the junction between the second fire-extinguishing agent container and the second line section. It is therefore possible to ensure that the fire-extinguishing agent remains at least essentially exclusively in the second fire-extinguishing agent container as long as a fire has not been detected in the cargo hold. The second closure is preferably securely attached to the second fire-extinguishing agent container.

A further advantageous refinement of the aircraft is distinguished by the fact that the second closure is embodied as a second single-use closure. The single-use closure is therefore preferably embodied in such a way that it cannot be closed again after opening. Instead, the opening of the second closure can cause a closure means of the second closure to be destroyed, with the result that a free line passage is made available through the second closure, which then ensures the flow of fire-extinguishing agent from the second fire-extinguishing agent container into the second line section. In other words, the second closure can be configured as a closure which cannot be closed again. Moreover, a single-use closure makes a particularly low level of complexity and/or a particularly low probability of failure possible. Such a single-use closure is therefore particularly functionally reliable.

A further advantageous refinement of the aircraft is distinguished by the fact that the second closure is coupled, in particular electrically, to the monitoring unit in such a way that the second closure can be opened, in particular irreversibly, by means of the monitoring unit. The pyrotechnic charge is preferably embodied in such a way that it can be fired, in particular electrically, by means of the monitoring unit. This then causes the second closure to open.

A further advantageous refinement of the aircraft is distinguished by the fact that the flow resistance of the second line section is lower than the flow resistance of the first line section, in particular when the valve is fully opened. This ensures that fire-extinguishing agent can flow particularly quickly from the second fire-extinguishing agent container to the cargo hold. A desired concentration of fire-extinguishing agent in the cargo hold can therefore be benched particularly rapidly. In order to maintain the concentration of fire-extinguishing agent in the cargo hold even over a relatively long period of time, the flow resistance through the first line section can be higher, since only a corresponding, often relatively small, quantity of fire-extinguishing agent is necessary to ensure the concentration of fire-extinguishing agent in the cargo hold at a desired value or within the desired value range. A particularly low level of complexity can be achieved by virtue of the above-mentioned configuration of the flow resistances of the line sections. Furthermore, the control valve can be made small, which in turn takes up less installation space in the aircraft. In other words, the configuration of the flow resistances which is explained above can permit a particularly compact configuration of the fire extinguishing-means to be achieved.

A further advantageous refinement of the aircraft is distinguished by the fact that the volume of the first fire-extinguishing agent container is greater than the volume of the second fire-extinguishing agent container. As explained above, the second fire-extinguishing agent container often serves to achieve the desired concentration of fire-extinguishing agent in the cargo hold particularly rapidly after a fire has been sensed in the cargo hold. In order to maintain the desired concentration of fire-extinguishing agent in the cargo hold even over a particularly long time, with the result that the aircraft can fly a correspondingly long distance, there is preferably provision that the volume of the first fire-extinguishing agent container is greater than the volume of the second fire-extinguishing agent container. A fire scenario in which the relatively large volume of the first fire-extinguishing agent container is particularly advantageous has respectively proven to be relevant. If the cargo hold accommodates a particularly large amount of cargo, the residual empty area or the residual empty volume of the cargo hold is particularly small. If, when there is a fire in the cargo hold, a leakage then occurs in the cargo hold, with the result that air or a mixture of gas can escape from the cargo hold as a result of the correspondingly leakage and/or an exchange occurs with air and/or gas in the surroundings of the cargo hold, it may be necessary for a particularly large flow of fire-extinguishing agent to be introduced into the cargo hold over a long time, in order to maintain the desired concentration of fire-extinguishing agent in the cargo hold. This is because the leakage in the cargo hold can cause the residual small volume or the residual small area to be subjected to a particularly high exchange rate with air and/or gas in the surroundings. This reduces the concentration of fire-extinguishing agent in the cargo hold particularly rapidly. For this reason, there is a need for a large flow of fire-extinguishing agent from the first fire-extinguishing agent container in the cargo hold. If the volume of the fire-extinguishing agent container is greater than the volume of the second fire-extinguishing agent container, this ensures that the desired concentration of fire-extinguishing agent can be maintained over a particularly long period of time in the cargo hold even in the case explained above.

A further advantageous refinement of the aircraft is distinguished by the fact that the monitoring unit is coupled, in particular electrically, to a control unit of the aircraft, wherein the control unit is configured to transmit a command signal to the monitoring unit, which command signal represents a landing state of the aircraft and/or an evacuation state of the aircraft. Furthermore, there is preferably provision that the monitoring unit is configured to actuate the controllable valve in such a way that the flow of fire-extinguishing agent from the first fire-extinguishing agent container to the cargo hold through the first line section is interrupted or ended if the command signal is transmitted to the monitoring unit. The monitoring unit is preferably connected to the control unit via a further electrical signal line. The command signal can therefore be transmitted from the control unit to the monitoring unit via this further signal line. This permits the introduction of fire-extinguishing agent into the cargo hold to be interrupted and/or ended if the aircraft has landed or is evacuated. The control unit can preferably sense one of the two states or each of the two states by means of a further sensor system of the aircraft. It is therefore possible to effectively prevent further fire-extinguishing agent, in particular under certain circumstances fire-extinguishing agent which it is not necessary to introduce, from flowing into the cargo hold. Environmental damage can therefore be particularly effectively minimised.

According to an aspect of the invention, a method is provided for monitoring a concentration of fire-extinguishing agent in a cargo hold of an aircraft which comprises a cargo hold, a first fire-extinguishing agent container with fluid-like fire-extinguishing agent, a first line section which extends from the first fire-extinguishing agent container to the cargo hold, with the result that fire-extinguishing agent can flow from the first fire-extinguishing agent container into the cargo hold, a controllable valve which is coupled to the first line section in such a way that a flow of fire-extinguishing agent through the first line section can be controlled by means of the valve, a concentration sensor which is arranged, in particular, in the cargo hold and is designed to sense a concentration of the fire-extinguishing agent in the cargo hold, and a monitoring unit, wherein the method has the steps: sensing a concentration of the fire-extinguishing agent in the cargo hold of the aircraft by means of the concentration sensor; transmitting the concentration sensor signal from the concentration sensor to the monitoring unit, wherein the concentration signal represents the sensed concentration of the fire-extinguishing agent in the cargo hold; and controlling the valve by means of the monitoring unit, with the result that the concentration of the fire-extinguishing agent in the cargo hold corresponds to a predetermined value or is within a predetermined value range. For the method, reference is made in an analogous fashion to the advantageous explanations, preferred features, effects and/or advantages such as have been explained in conjunction with the aircraft.

A further advantageous refinement of the method is distinguished by the fact that the aircraft also has a control unit which is coupled to the monitoring unit and which is configured to transmit a command signal to the monitoring unit, which command signal represents a landing state of the aircraft and/or an evacuation state of the aircraft, wherein the method also has the step: controlling the controllable valve by means of the monitoring unit, with the result that the flow of fire-extinguishing agent from the first fire-extinguishing agent container to the cargo hold through the first line section is interrupted and/or ended if the command signal has been transmitted to the monitoring unit. Reference is preferably made in an analogous fashion to the corresponding advantageous explanations, preferred features, effects and/or advantages such as have been explained in conjunction with the corresponding refinement of the aircraft, and in an analogous fashion the above-explained refinement of the method.

### BRIEF DESCRIPTION OF THE DRAWINGS

Further features, advantages and application possibilities of the present invention emerge from the following description of the exemplary embodiments and the figures. In this context, all the features which are described and/or illustrated figuratively form, per se and in any desired combination, the subject matter of the invention even independently of their configuration in the individual claims or their back-references. Furthermore, the same reference symbols are used for identical or similar objects in the figures. In the drawings:

FIG. 1 shows an advantageous refinement of an aircraft in a schematic perspective view,

FIG. 2 shows the fuselage of an advantageous refinement of an aircraft in a schematic sectional illustration,

FIG. 3 shows advantageous parts and/or areas of an advantageous refinement of an aircraft which serve for the controlled flowing of fire-extinguishing agent into a cargo hold of the aircraft, and

FIG. 4 shows advantageous parts and/or areas of further advantageous refinement of an aircraft which serve for the controlled flowing of fire-extinguishing agent into a cargo hold of the aircraft.

### DETAILED DESCRIPTION

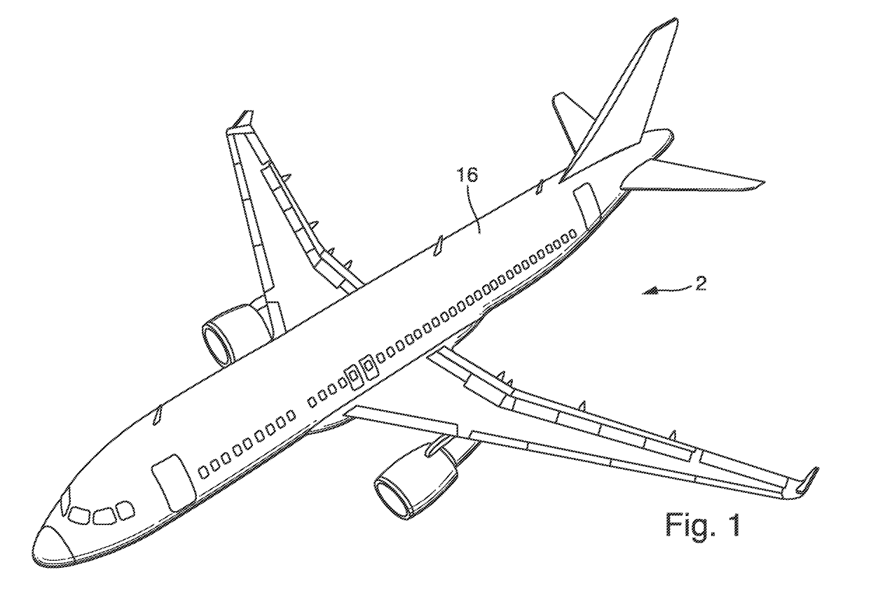

FIG. 1 represents an aircraft 2 in a schematic illustration. The aircraft 2 is preferably a passenger aircraft 2. The aircraft 2 has a fuselage 16.

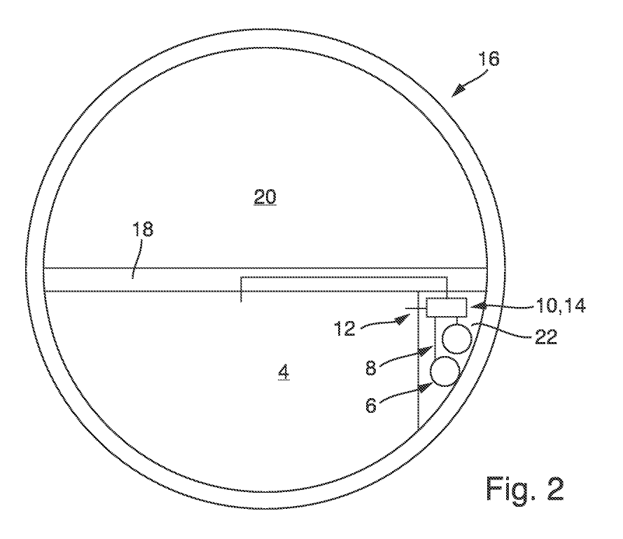

In FIG. 2, the fuselage 16 is represented purely schematically in a cross-sectional illustration. The interior of the fuselage 16 can be divided, for example, into a cabin hold 20 and a cargo hold 4 by means of a floor 18. The cabin hold 20 is also referred to as a cabin area 20 or as a cabin 20 for short. Passengers can be seated in the cabin 20. For this purpose, seats are provided in the cabin 20. Freight can be accommodated in the cargo hold 4. The cargo hold 4 is correspondingly configured for this.

If a fire occurs in the cargo hold 4, it is important for it to be extinguished or suppressed as rapidly as possible.

In order to carry along fire-extinguishing agent for extinguishing a fire, the aircraft 2 has a first fire-extinguishing agent container 6 with a fluid-like fire-extinguishing agent. Furthermore, a first line section 8 is provided for the aircraft 2, said first line section 8 extending from the first fire-extinguishing agent container 6 to the cargo hold 4, with the result that the fire-extinguishing agent can flow from the first fire-extinguishing agent container 6 into the cargo hold 4. The first fire-extinguishing agent 6 and the first line section 8 can be arranged within the cargo hold 4.

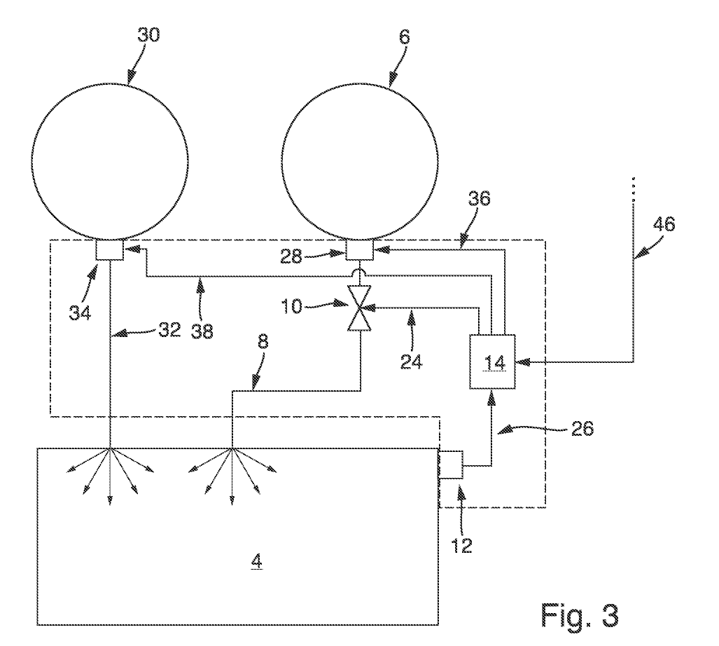

The first fire-extinguishing agent container 6, the first line section 8 as well as further preferred features of the aircraft 2 which serve for extinguishing a fire in the cargo hold 4 are illustrated schematically in an advantageous configuration in FIG. 3. In this context there is furthermore preferably provision that the elements which are outlined in the boxes made of dashed lines are preferably arranged in the area 22 of the interior of the fuselage 16. The first fire-extinguishing agent 6 can also be arranged in this area 22. The area 22 can be assigned to the cargo hold 4. In FIG. 3, the rest of the cargo hold 4 is illustrated purely schematically as a hold with a rectangular cross section. However, the cargo hold 4 is not to be restricted to this shape.

As is apparent, for example, from FIG. 3, there is preferably provision that a controllable valve 10 is coupled to the first line section 8 in such a way that a flow of fire-extinguishing agent through the first line section 8 can be controlled by means of the valve 10. The valve 10 is preferably an electrically controllable throttle valve 10. The valve 10 can therefore be designed to control the outlet cross section through the valve 10. The valve 10 is preferably an electromechanical valve 10, in particular an electromagnetic valve 10. The valve 10 can therefore be embodied in such a way that it can be controlled by means of an electrical signal in order to adapt the outlet cross section in a controlled fashion. By changing the outlet cross section it is possible to control the flow of fire-extinguishing agent through the valve 10 and therefore also through the first line section 8.

Moreover, a monitoring unit 14 is provided for the aircraft 2, which monitoring unit 14 is coupled, in particular electrically, to the valve 10 in order to control said valve 10, so as to control the flow of fire-extinguishing agent by controlling the valve 10 by means of the monitoring unit 14. The monitoring unit 14 is therefore preferably electrically coupled to the valve 10 via an electrical valve control line 24. The monitoring unit 14 can therefore transmit an electrical control signal to the valve 10 via the valve control signal line 24. The valve 10 can therefore be controlled by the monitoring unit 14 by means of the corresponding control signals.

A preferred objective is for the monitoring unit 14 to control the valve 10 in such a way that a concentration of fire-extinguishing agent which is achieved in the cargo hold 4 corresponds to a predetermined value of a concentration for the fire-extinguishing agent or is within a predetermined value range for the concentration of the fire-extinguishing agent. In order to ensure this, a concentration sensor 12 for the aircraft 2 is also provided. The concentration sensor 12 can be arranged within the cargo hold 4. However, it is also possible for the concentration sensor 12 to be arranged only partially within the cargo hold 4, on an outer wall 26 of the cargo hold 4 and/or at some other location within the aircraft at which it is possible to sense the concentration of the fire-extinguishing agent within the cargo hold 4. The concentration sensor 12 is designed here to sense a concentration of the fire-extinguishing agent which is also referred to as the fire-extinguishing agent concentration, in the cargo hold 4. This may be a mass concentration or a volume concentration. The concentration sensor 12 is also coupled, in particular electrically, to the monitoring unit 14. The concentration sensor 12 can be electrically connected to the monitoring unit 14 by means of a first sensor signal line 26. The concentration sensor 12 is therefore preferably designed to transmit a concentration sensor signal to the monitoring unit 14 via the first sensor signal line 26, wherein the concentration sensor signal represents the concentration, sensed by means of the concentration sensor 12, of the fire-extinguishing agent in the cargo hold 4. The monitoring unit 14 therefore receives the information about the actual concentration of the fire-extinguishing agent in the cargo hold 4 via the concentration sensor 12. Moreover, there is preferably provision that the predetermined value or the predetermined value range for the designed concentration of the fire-extinguishing agent in the cargo hold 4 is stored by the monitoring unit 14. It is therefore possible for the monitoring unit 14 to actuate the valve 10 in such a way that the desired concentration of the fire-extinguishing agent in the cargo hold 4 is achieved. Therefore, the monitoring unit 14 is configured to control the valve 10 on the basis of the actually sensed concentration in such a way that the actual concentration of fire-extinguishing agent in the cargo hold 4 corresponds to the predetermined value or is within the predetermined value range, each for the concentration of fire-extinguishing agent. This ensures that the concentration of the fire-extinguishing agent in the cargo hold 4 is regulated.

This provides the advantage that only the quantity of fire-extinguishing agent which is actually necessary to extinguish or suppress the fire flows into the cargo hold 4. Therefore, there can be a particularly effective saving in fire-extinguishing agent and at the same time the environment can be damaged less. Furthermore, the flow of fire-extinguishing agent can be adapted autonomously. If a leakage occurs in the cargo hold which brings about an increased exchange of volume of the air and/or of the gas from the cargo hold 4 with the environment, a changing concentration of the fire-extinguishing agent is sensed quite automatically by the concentration sensor 12, as a result of which the valve 10 is in turn automatically actuated by means of the monitoring unit 14, in order to restore that concentration of the fire-extinguishing agent in the cargo hold 4 which corresponds to the predetermined value or the predetermined value range.

It is also apparent in a purely exemplary fashion from FIG. 3, there is preferably provision that a first closure 28 is assigned to the first fire-extinguishing agent container 6. The first closure 28 is coupled to the first line section 8 in such a way that opening of the first closure 28 brings about or at least ensures a flow of fire-extinguishing agent from the first fire-extinguishing agent container 6 to the valve 10. The first closure 28 is preferably a single-use closure 28. The opening of the first closure 28 can therefore only be carried out irreversibly. The first closure 28 can for this purpose have, for example, a charge which can be fired pyrotechnically. The firing of the pyrotechnic charge can take place electrically. There is therefore preferably a provision that a first electrical firing line 36 leads from the monitoring unit 14 to the first closure 28. The first closure 28 can therefore be electrically coupled to the monitoring unit 14, with the result that the first closure 28 can be irreversibly opened by means of the monitoring unit 14. The monitoring unit 14 can for this purpose send, for example, an electrical pulse or an electrical signal to the pyrotechnic charge of the first closure 28, with the result that the latter destroys an associated closure means, which establishes the fluid connection between the interior of the first fire-extinguishing agent container 6 and the first line section 8.

Moreover, it has proven advantageous if a second fire-extinguishing agent container 30 is provided for the aircraft 2. Preferably the same fluid-like fire-extinguishing agent is stored in the second fire-extinguishing agent container 30 as in the first fire-extinguishing agent container 6. Furthermore, a second line section 32 extends from the second fire-extinguishing agent container 30 to the cargo hold 4, with the result that fire-extinguishing agent can flow from the second fire-extinguishing agent container 30 into the cargo hold 4. The second fire-extinguishing agent container 30 and the second line section 32 can be arranged within the cargo hold 4. Moreover, a second closure 34 is provided. The second closure 34 is preferably assigned to the second fire-extinguishing agent container 30. Furthermore, there is provision that the second closure 34 is coupled to the second line section 32 in such a way that opening of the second closure 34 brings about an, in particular unmonitored, non-interruptible and/or unregulated, flow of fire-extinguishing agent from the second fire-extinguishing agent container 30 to the cargo hold 4 through the second line section 32. The second closure 34 as such can be in an analogous fashion to the first closure 28. Therefore, reference is made in an analogous fashion to the preceding explanations, advantageous features and/or effects such as have been explained in conjunction with the first closure 28. The monitoring unit 14 can therefore be electrically coupled to the second closure 34 by means of a second electrical firing signal line 38. The monitoring unit 14 can therefore transmit an electrical firing signal to the second closure 34 via the second electrical firing signal line 38, which preferably causes the pyrotechnic charge of the second closure 34 to fire. A corresponding closure means of the second closure 34 can therefore be destroyed, which causes the second closure 34 to open. The firing agent subsequently flows out of the second fire-extinguishing agent container 30 into the cargo hold 4 through the second line section 32. This ensures that the concentration of fire-extinguishing agent in the cargo hold 4 reaches at least a desired value as rapidly as possible directly after the detection of a fire in the cargo hold 4. In order to also continue to maintain the desired concentration of fire-extinguishing agent in the cargo hold 4, the concentration of fire-extinguishing agent in the cargo hold 4 can be sensed by means of the concentration sensor 12, and the corresponding concentration signal can be passed onto the monitoring unit 14. The latter can then control the valve 10 on the basis thereof to control the flow of fire-extinguishing agent from the first fire-extinguishing agent container 6 into the cargo hold 4 via the first line section 8 in such a way that the desired concentration is maintained.

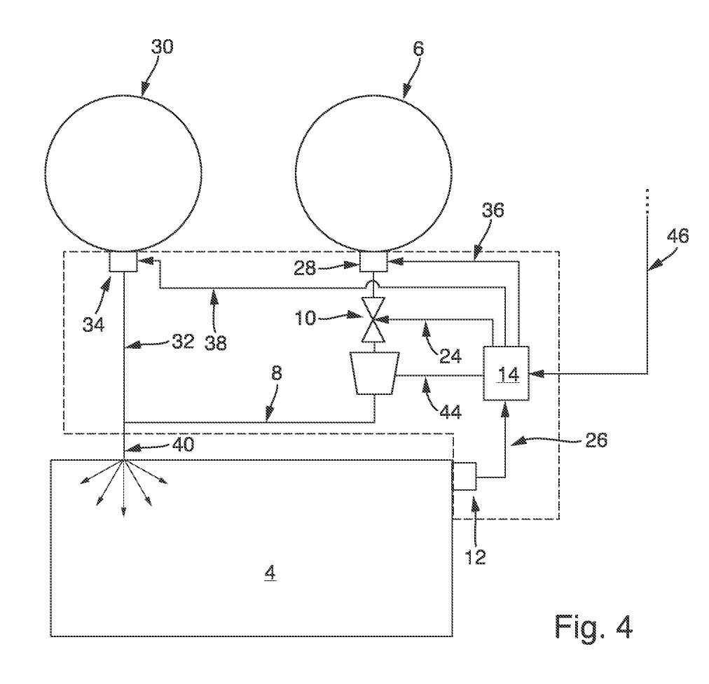

As is apparent in a purely exemplary fashion from FIG. 3 there may be provision that the first line section 8 is embodied separately from the second line section 32. FIG. 4 shows a slightly changed configuration variant of the parts of the aircraft 2 which are shown in FIG. 3.

FIG. 4 shows in schematic form that the first line section 8 and the second line section 32 can be formed together in the end section 40 which faces the cargo hold 4. Moreover, FIG. 4 shows schematically that a flow sensor 42 can be coupled to the first line section 8 in such a way that a flow of fire-extinguishing agent through the first line section 8 can be sensed by the flow sensor 42. In this context, the flow sensor 42 can sense, for example, the volume flow of the fire-extinguishing agent or the mass flow of the fire-extinguishing agent. The flow sensor 42 is coupled, in particular electrically, to the monitoring unit 14 via a further sensor signal line 44, with the result that a flow sensor signal can be transmitted from the flow sensor 42 to the monitoring unit 14, wherein the flow sensor signal represents the flow of fire-extinguishing agent which is sensed by the flow sensor 42. This corresponding sensor information can be taken into account by the monitoring unit 14 during the control of the valve 10. The monitoring unit 14 is therefore preferably configured to control the valve 10 on the basis of the sensed concentration and the sensed flow of fire-extinguishing agent in such a way that the concentration of the fire-extinguishing agent in the cargo hold 4 corresponds to the predetermined value or is within the predetermined value range. Taking into account the sensed flow of fire-extinguishing agent provides the advantage here that the desired concentration can be reached particularly rapidly and/or can also be maintained particularly precisely.

Furthermore, there is preferably provision for an aircraft 2 that the latter has a control unit (not illustrated), in particular a central control unit. The monitoring unit 14 can be coupled directly or indirectly to this control unit of the aircraft 2 via corresponding signal lines 46 which are each illustrated partially in FIGS. 3 and 5. The control unit is preferably also configured to transmit a command signal directly or indirectly to the monitoring unit 14 via the signal line 46, which represents a landing state of the aircraft 2 and/or an evacuation state of the aircraft 2. This provides the advantage that the monitoring unit 14 receives the information about at least one of the two states specified above, which permits the further introduction of fire-extinguishing agent into the cargo hold 4 to be interrupted or ended. This is because it is then possible for the fire in the cargo hold 4 of the aircraft 2 to be extinguished by the ground staff at the airport. The monitoring unit 14 is therefore preferably configured to actuate the valve 10 in such a way that the flow of fire-extinguishing agent from the first fire-extinguishing agent container 6 to the cargo hold 4 through the first line section 8 is ended and/or interrupted if the command signal is transmitted from the control unit of the aircraft 2 to the monitoring unit 14.

In addition, it is to be noted that “having” does not exclude other elements or steps and “a” does not exclude a plurality. In addition, it is to be noted that features which have been described with reference to one of the above exemplary embodiments can also be used in combination with other features of other exemplary embodiments described above. Reference symbols in the claims are not to be considered limiting.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft comprising:
a cargo hold;
a first fire-extinguishing agent container with a fluid-like fire-extinguishing agent;
a first line section extending from the first fire-extinguishing agent container to the cargo hold, such that the fire-extinguishing agent is configured to flow from the first fire-extinguishing agent container into the cargo hold;
a controllable valve coupled to the first line section and configured to control a flow of fire-extinguishing agent through the first line section;
a concentration sensor arranged in the cargo hold and configured to sense a concentration of the fire-extinguishing agent in the cargo hold; and
a monitoring unit,
wherein the concentration sensor is coupled to the monitoring unit in such a way as to transmit to the monitoring unit a concentration sensor signal representing the sensed concentration of the fire-extinguishing agent in the cargo hold,
wherein, the monitoring unit is coupled to the valve and configured to control the valve to control the flow of the fire extinguishing agent, and
wherein the monitoring unit is configured to control the valve on the basis of the sensed concentration in such a way that the concentration of the fire-extinguishing agent in the cargo hold corresponds to a predetermined value or is within a predetermined value range.

2. The aircraft according to claim 1, further comprising a flow sensor, the flow sensor being coupled to the first line section and configured to sense a flow of fire-extinguishing agent through the first line section, wherein the flow sensor is coupled to the monitoring unit in such a way as to transmit to the monitoring unit a flow sensor signal representing the sensed flow of fire-extinguishing agent, and the monitoring unit is configured to control the valve also on the basis of the sensed flow of fire-extinguishing agent.

3. The aircraft according to claim 1, further comprising a first closure coupled to the first line section in such a way that opening of the first closure ensures or brings about a flow of fire-extinguishing agent from the first fire-extinguishing agent container to the valve.

4. The aircraft according to claim 3, wherein the first closure is embodied as a first single-use closure.

5. The aircraft according to claim 3, wherein the first closure is coupled to the monitoring unit in such a way that the first closure is configured to be irreversibly opened by the monitoring unit.

6. The aircraft according to claim 1, further comprising: a second fire-extinguishing agent container with a or the same fluid-like fire-extinguishing agent, a second line section extending from the second fire-extinguishing agent container to the cargo hold, such that the fire-extinguishing agent is configured to flow from the second fire-extinguishing agent container into the cargo hold, and a second closure coupled to the second line section in such a way that opening of the second closure brings about a flow of fire-extinguishing agent from the second fire-extinguishing agent container to the cargo hold through the second line section.

7. The aircraft according to claim 6, wherein the second closure is embodied as a second single-use closure.

8. The aircraft according to claim 6, wherein the second closure is coupled to the monitoring unit in such a way that the second closure is configured to be irreversibly opened by the monitoring unit.

9. The aircraft according to claim 6, wherein the flow resistance of the second line section is smaller than the flow resistance of the first line section, when the valve is fully opened.

10. The aircraft according to claim 6, wherein the volume of the first fire-extinguishing agent container is greater than the volume of the second fire-extinguishing agent container.

11. The aircraft according to claim 1, wherein the monitoring unit is coupled to a control unit of the aircraft, the control unit is configured to transmit a command signal representing a landing state of the aircraft and/or an evacuation state of the aircraft to the monitoring unit, and the monitoring unit is configured to actuate the valve in such a way that the flow of fire-extinguishing agent from the first fire-extinguishing agent container to the cargo hold through the first line section is interrupted if the command signal is transmitted to the monitoring unit.

12. A method for monitoring a concentration of fire-extinguishing agent in a cargo hold of an aircraft comprising a cargo hold, a first fire-extinguishing agent container with fluid-like fire-extinguishing agent, a first line section extending from the first fire-extinguishing agent container to the cargo hold, such that the fire-extinguishing agent is configured to flow from the first fire-extinguishing agent container into the cargo hold, a controllable valve coupled to the first line section in such a way that a flow of fire-extinguishing agent through the first line section configured to be controlled by the valve, a concentration sensor arranged in the cargo hold and configured to sense a concentration of the fire-extinguishing agent in the cargo hold, and a monitoring unit, wherein the method comprises:
sensing a concentration of a fire-extinguishing agent in the cargo hold of the aircraft by the concentration sensor;
transmitting the concentration sensor signal from the concentration sensor to the monitoring unit, wherein the concentration sensor signal represents the sensed concentration of the fire-extinguishing agent in the cargo hold; and
controlling the valve by the monitoring unit, such that the concentration of the fire-extinguishing agent in the cargo hold corresponds to a predetermined value or is within a predetermined value range.

13. The method according to claim 12, wherein the aircraft further comprises a control unit coupled to the monitoring unit and configured to transmit a command signal to the monitoring unit, the command signal representing a landing state of the aircraft and/or an evacuation state of the aircraft, wherein the method further comprises: controlling the valve by the monitoring unit, such that the flow of fire-extinguishing agent from the first fire-extinguishing agent container to the cargo hold through the first line section is interrupted if the command signal has been transmitted to the monitoring unit.
